(19) United States
(12) Patent Application Publication
(10) Pub. No.: US 2010/0140318 A1
(43) Pub. Date: Jun. 10, 2010

(54) STAPLER

(76) Inventors: Chun-Yuan Wang, TAIPEI CITY (TW); Hsiao-Cheng Chen, TAIPEI CITY (TW); Cheng-Yi Lee, TAIPEI CITY (TW)

Correspondence Address: NORTH AMERICA INTELLECTUAL PROPERTY CORPORATION, P.O. BOX 506, MERRIFIELD, VA, 22116, US

(21) Appl. No.: 12/623,447

(22) Filed: Nov. 23, 2009

(30) Foreign Application Priority Data
Dec. 5, 2008 (TW) 097147486

(51) Int. Cl. B25C 7/00

(52) U.S. Cl. 227/156

(57) ABSTRACT

A stapler includes a main body, a light-emitting module, and an optical module. The main body has a stapling portion. The light-emitting module is disposed in the main body. The optical module faces the light-emitting module. Light emitted from the light-emitting module is converted into a light spot with a linear shape by the optical module to mark a stapling position of the stapling portion.

### CROSS-REFERENCE TO RELATED APPLICATIONS

This Non-provisional application claims priority under 35 U.S.C. §119(a) on Patent Application No(s). 097147486 filed in Taiwan, Republic of China on Dec. 5, 2008, the entire contents of which are hereby incorporated by reference.

### BACKGROUND OF THE INVENTION

1. Field of the Invention

The invention relates to a stapler and, more particularly, to a stapler having an optical positioning function.

2. Description of the Related Art

Generally in an office, various kinds of stationery, such as pens, correction articles, and staplers, are necessary for use. Further, the staples for stapling documents are very important.

FIG. 1 is a schematic diagram showing a conventional stapler 1. The stapler 1 has a stapling portion 11, a casing 12, a staple cartridge 13, and a staple base 14. The stapling portion 11 is fixed to the casing 12. The staple cartridge 13 and the casing 12 are pivotally connected with the staple base 14.

Therefore, a staple (not shown) in the staple cartridge 13 can be pushed out from the staple cartridge 13 by the stapling portion 11 fixed at the casing 12 through pressing the casing 12. The staple is then blocked by a staple anvil 141 of the staple base 14 to been bent after it passes through a plurality of sheets of paper P, therefore, the sheets of the paper are stapled and fixed.

However, before using the conventional stapler 1 to staple sheets of paper, a user cannot exactly know the position of the staple. Therefore, the stapling position may be wrong or staples at the same file may fail to be aligned with each other thus to generate inconvenience in use.

### BRIEF SUMMARY OF THE INVENTION

This invention provides a stapler having a positioning function before stapling to improve the prior art.

According to one aspect of the invention, a stapler in the invention includes a main body, a light-emitting module, and an optical module. The main body has a stapling portion. The light-emitting module is disposed in the main body. The optical module faces the light-emitting module. Light emitted from the light-emitting module is converted into a light spot with a linear shape by the optical module to mark a stapling position of the stapling portion.

In one embodiment of the invention, the optical module may include a lens element. The light emitted from the light-emitting module may be converted into the light spot with the linear shape through the lens element. The lens element may have an optical structure. The optical structure may be disposed at a surface of the lens element facing the light-emitting module or a surface of the lens element opposite to another surface facing the light-emitting module.

In one embodiment of the invention, the stapler may further include a triggering module electrically connected with the light-emitting module. When the staple cartridge is at a predetermined distance from the staple base, the triggering module may be triggered to control the light-emitting module to emit the light.

In one embodiment of the invention, the stapler may further include a sensing module. When the sensing module senses that the sensing module is at a predetermined distance from the staple base, the sensing module may control the light-emitting module to emit the light.

To sum up, the stapler in the invention emits the light spot with the linear shape by the cooperation between the light-emitting module and the optical module. In other words, the stapler generates a positioning line by the cooperation between the light-emitting module and the optical module. Thereby, the stapler in the invention has the positioning function before stapling, such that a user can clearly know the stapling position in advance to avoid generating wrong stapling positions or other problems. In addition, the stapler in the embodiments of the invention may further include the triggering module or the sensing module. The light-emitting module may be automatically switched on by the triggering module or the sensing module, thereby being capable of saving power and improving convenience in use.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a conventional stapler;

FIG. 2 is a partial sectional side view showing a stapler according to one preferred embodiment of the invention;

FIG. 3A is a schematic diagram showing a stapler in use according to one preferred embodiment of the invention;

FIG. 3B is a partial sectional side view showing a stapler in use according to one preferred embodiment of the invention;

FIG. 4A and FIG. 4B are schematic diagrams showing an optical module in different forms according to one embodiment of the invention; and

FIG. 5 is a partial sectional diagram showing a stapler in another form according to another embodiment of the invention.

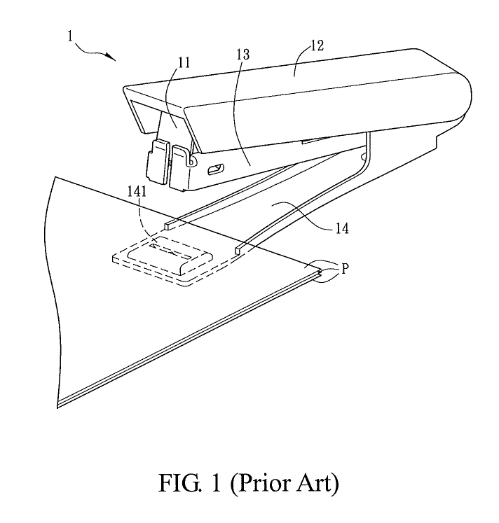

### DETAILED DESCRIPTION OF THE INVENTION

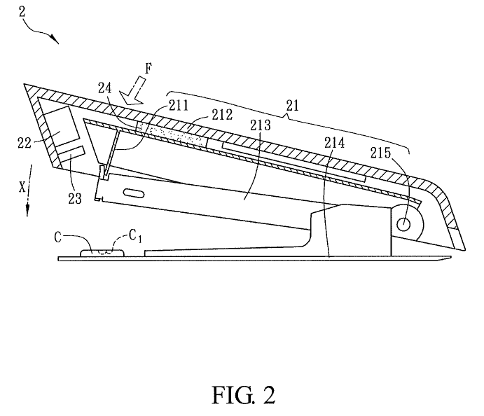

FIG. 2 is a partial sectional side view showing a stapler 2 according to one preferred embodiment of the invention. The stapler 2 includes a main body 21, a light-emitting module 22, and an optical module 23.

The main body 21 has a stapling portion 211. In addition, in the embodiment, the main body 21 can further have a casing 212, a staple cartridge 213, a staple base 214, and a hinge 215. However, the invention is not limited thereto.

The stapling portion 211 is disposed in the casing 212. The staple cartridge 213 is sandwiched between the casing 212 and the staple base 214. The casing 212, the staple cartridge 213, and the staple base 214 are pivotally connected by the hinge 215. The staple base 214 has a staple anvil C disposed corresponding to the stapling portion 211 and having a formed recess C₁.

In the embodiment, the light-emitting module 22 and the optical module 23 are disposed in the casing 212. However, the positions of the light-emitting module 22 and the optical module 23 are not limited thereto. The light-emitting module 22 is disposed in the main body 21 and has a point light source. The invention is not limited thereto. The light-emitting module 22 may be a laser light-emitting module or a light-emitting diode (LED) light-emitting module. However, the invention is not limited thereto.

The optical module 23 faces the light-emitting module 22. That is, the optical module 23 is disposed at a light path of light emitted from the light-emitting module 22. The light emitted from the light-emitting module 22 is converted into a light spot with a linear shape by the optical module 23 to mark a stapling position of the stapling portion 211.

In addition, in the embodiment, the stapler 2 can further include a battery module 24. The battery module 24 is electrically connected with the light-emitting module 22 to provide power for the light-emitting module 22. The battery module 24 may be a primary battery or a secondary battery.

Therefore, when a user exerts external force F onto the casing 212, the casing 212 rotates around the hinge 215 along a direction X and drives the stapling portion 211 and the staple cartridge 213 to rotate along the direction X.

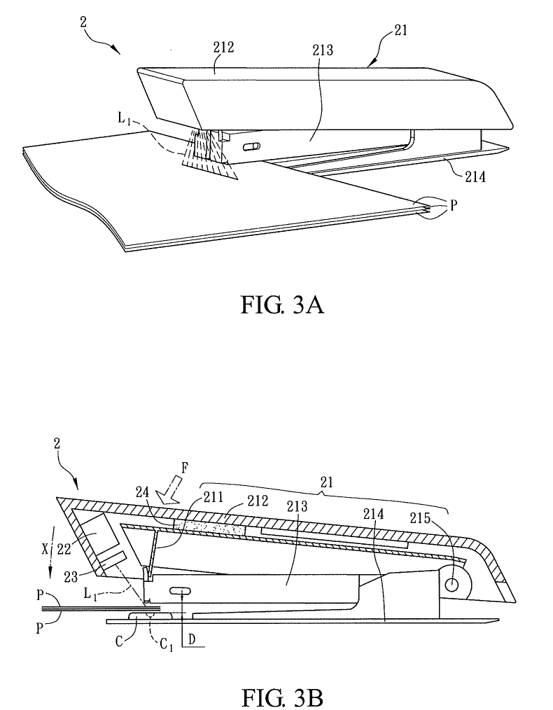

FIG. 3A is a schematic diagram showing the stapler 2 in use according to the embodiment. FIG. 3B is a partial sectional side view showing the stapler 2 in use according to the embodiment.

In FIG. 3A and FIG. 3B, when the staple cartridge 213 is at a predetermined distance D from the staple anvil C (or the casing 212 is at the predetermined distance D from the staple base 214; and further, the elements can be crosswise paired and the different predetermined distances D may be set as needed), the light emitted from the light-emitting module 22 is converted into the light spot L₁ with the linear shape by the optical module 23 and is projected onto the staple anvil C afterward. The light is overlapped with the formed recess C₁. Thus, a mark line is formed on a sheet of paper as a positioning line. The predetermined distance D may be shorter than 3 mm. However, the invention is not limited thereto.

Furthermore, an angle between the light spot L₁ with the linear shape and the paper P is adjusted according to a relative position of the light-emitting module 22 and the corresponding formed recess C₁. The angle is not limited to 90 degrees. In FIG. 3B, the light-emitting module 22 and the optical module 23 are both disposed at one side of the casing 212. At that moment, the light spot L₁ with the linear shape provided by the two modules is projected onto the formed recess C₁ non-vertically.

Then, the user can continue to exert the external force F onto the casing 212. A staple in the staple cartridge 213 is pressed by the stapling portion 211 fixed to the casing 212 and is pushed out from the staple cartridge 213. After the staple passes through a plurality of sheets of the paper P along the light spot L₁ with the linear shape , the staple is blocked by the formed recess C₁ of the staple anvil C to been bent, therefore, the sheets of the paper P are stapled and fixed.

Thus, the stapler 2 has a positioning function before stapling. The user can clearly know and see the stapling position in advance to avoid causing wrong stapling positions or other problems.

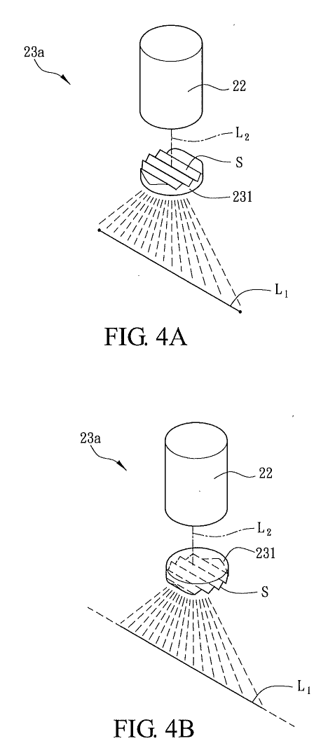

FIG. 4A and FIG. 4B are schematic diagrams showing the optical module 23a in different forms according to the embodiment. The optical module 23a can include a lens element 231. Light L₂ emitted from the light-emitting module 22 is converted into the light spot L₁ with the linear shape through the lens element 231. The lens element 231 may be a wave lens. The lens element 231 can have an optical structure S. The optical structure S is disposed at a surface of the lens element 231 facing the light-emitting module 22 (as shown in FIG. 4A) or a surface of the lens element 231 opposite to another surface facing the light-emitting module 22 (as shown in FIG. 4B).

In FIG. 4A, the optical structure S is disposed at the surface of the lens element 231 facing the light-emitting module 22. When the light spot L₁ with the linear shape passing through the lens element 231 is projected onto the staple anvil C, the two ends of the light spot L₁ with the linear shape are clear. In FIG. 4B, the optical structure S is disposed at the surface of the lens element 231 opposite to another surface facing the light-emitting module 22. When the light spot L₁ with the linear shape passing through the lens element 231 is projected onto the staple anvil C, the two ends of the light spot L₁ with the linear shape are unclear. Thus, different application modes may be available according to different needs.

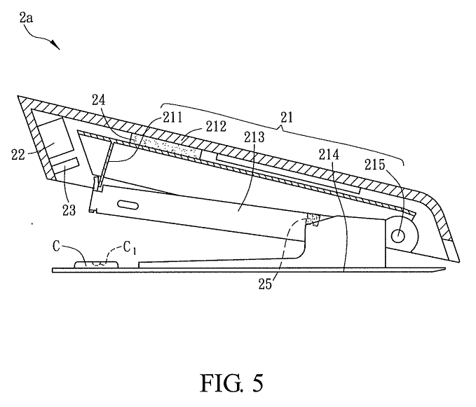

FIG. 5 is a partial sectional view showing a stapler 2a in another form according to another embodiment. The stapler 2a in this embodiment can further include a triggering module 25 electrically connected with the light-emitting module 22. When the triggering module 25 is at a predetermined distance from the staple anvil C, a switching element of the triggering module 25 can be triggered after pressed, and the triggering module 25 can control the light-emitting module 22 to emit the light.

In FIG. 5, in this preferred embodiment, the triggering module 25 is a switching element having a press button and is disposed in the casing 212. When the triggering module 25 is at the predetermined distance from the staple anvil C, since the press button is pressed by the staple base 214, the triggering module 25 is triggered and controls the light-emitting module 22 to emit the light. However, the press button not shown in FIG. 5 may also be disposed at an outer surface of the casing 212. When the user holds the main body 21 of the stapler 2a, one hand of the user can touch the press button to allow the triggering module 25 to be triggered. That is, the operating mode and the position of the triggering module 25 may have different designs according to different needs. The invention is not limited thereto.

Therefore, via the triggering module 25, the light-emitting module 22 can be automatically switched on before stapling thus to prevent the light-emitting module 22 from being continuously on to waste power. Furthermore, the light-emitting module 22 is switched on automatically by the triggering module 25, which improves the convenience in use.

In addition, in order to automatically control the light-emitting module 22, a sensing module (such as an infrared sensing element) can be used. When the sensing module senses that it is the predetermined distance from itself to the staple anvil C, the sensing module can control the light-emitting module 22 to emit the light. Thus, the stapler 2a can also automatically switch on the light-emitting module 22 to improve the convenience in use. As described above, the position of the sensing module may vary with different needs. The invention is not limited thereto.

To sum up, the stapler in the embodiments of the invention emits the light spot with the linear shape by the cooperation between the light-emitting module and the optical module. In other words, the stapler generates a positioning line by the cooperation between the light-emitting module and the optical module. Thereby, the stapler in the embodiments of the invention has the positioning function before stapling, such that a user can clearly know the stapling position in advance to avoid generating wrong stapling positions or other problems. In addition, the stapler in the embodiments of the invention can further include the triggering module or the sensing module. The light-emitting module can be automatically switched on by the triggering module or the sensing module. Thus, the light-emitting module can be prevented from being continuously on to save power, and convenience in use can be improved.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A stapler comprising:
a main body having a stapling portion;
a light-emitting module disposed in the main body; and
an optical module facing the light-emitting module, wherein light emitted from the light-emitting module is converted into a light spot with a linear shape by the optical module to mark a stapling position of the stapling portion.

2. The stapler according to claim 1, wherein the light-emitting module is a laser light-emitting module or a light-emitting diode (LED) light-emitting module.

3. The stapler according to claim 1, wherein the light-emitting module has a point light source for emitting the light.

4. The stapler according to claim 1, wherein the light-emitting module comprises a lens element, and the light emitted from the light-emitting module is converted into the light spot with the linear shape through the lens element.

5. The stapler according to claim 4, wherein the lens element is a wave lens.

6. The stapler according to claim 4, wherein the lens element comprises an optical structure disposed at a surface of the lens element facing the light-emitting module.

7. The stapler according to claim 4, wherein the lens element comprises an optical structure disposed at a surface of the lens element opposite to another surface of the lens element facing the light-emitting module.

8. The stapler according to claim 1, wherein the main body further comprises a casing, a staple base, and a staple cartridge sandwiched between the casing and the staple base, and the stapling portion is contained in the main body.

9. The stapler according to claim 8, wherein the light-emitting module and the optical module are disposed in the casing.

10. The stapler according to claim 8, wherein the main body further has a hinge, and the casing, the staple base, and the staple cartridge are pivotally connected by the hinge.

11. The stapler according to claim 8, wherein the staple base comprises a staple anvil disposed corresponding to the stapling portion, and the staple anvil has a formed recess.

12. The stapler according to claim 11, wherein the light is projected onto the staple anvil after the light emitted from the light-emitting module is converted into the light spot with the linear shape by the optical module, and overlapped with the formed recess.

13. The stapler according to claim 8, further comprising:
a triggering module electrically connected with the light-emitting module, when the staple cartridge is at a predetermined distance from the staple base, the triggering module being triggered to control the light-emitting module to emit the light.

14. The stapler according to claim 8, further comprising:
a sensing module electrically connected with the light-emitting module, when the sensing module senses that the sensing module is at a predetermined distance from the staple base, the sensing module controlling the light-emitting module to emit the light.

15. The stapler according to claim 1, further comprising:
a battery module electrically connected with the light-emitting module.

16. The stapler according to claim 15, wherein the battery module is a secondary battery.
